(19) United States
(12) Patent Application Publication
(10) Pub. No.: US 2026/0313642 A1
(43) Pub. Date: Oct. 8, 2026

(54) MINIMUM OFFSET VALUE FOR UNUSED TRANSMISSION OCCASION INDICATION

(71) Applicant: QUALCOMM Incorporated, San Diego, CA (US)

(72) Inventors: Zhichao ZHOU, Beijing (CN); Diana MAAMARI, San Diego, CA (US); Mickaël MONDET, Louannec (FR)

(21) Appl. No.: 19/479,131

(22) PCT Filed: Jul. 3, 2023
(86) PCT No.: PCT/CN2023/105488

§ 371 Date: Oct. 27, 2025

(51) Int. Cl. H04W 72/1268; H04L 5/00; H04W 72/51; H04W 76/20; H04W 80/02

(52) U.S. Cl. CPC H04W 72/1268; H04L 5/0044; H04W 72/51; H04W 76/20; H04W 80/02

(57) ABSTRACT

Various aspects of the present disclosure generally relate to wireless communication. In some aspects, a user equipment (UE) may receive offset information associated with a minimum offset between a scheduling grant and a corresponding physical uplink shared channel communication. The UE may transmit an indication of an unused transmission occasion (TO) based at least in part on a time duration between an uplink TO for the indication and the unused TO being equal to or greater than the minimum offset. Numerous other aspects are described.

### INTRODUCTION

Aspects of the present disclosure generally relate to wireless communication and to techniques and apparatuses for indicating unused transmission occasions.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed at a user equipment (UE). The method may include receiving offset information associated with a minimum offset between a scheduling grant and a corresponding physical uplink shared channel (PUSCH) communication. The method may include transmitting an indication of an unused transmission occasion (TO) based at least in part on a time duration between an uplink TO for the indication and the unused TO being equal to or greater than the minimum offset.

Some aspects described herein relate to a method of wireless communication performed at a network entity. The method may include generating offset information associated with a minimum offset between a scheduling grant and a corresponding PUSCH communication and associated with a UE determining to transmit an indication of an unused TO. The method may include transmitting the offset information.

Some aspects described herein relate to an apparatus for wireless communication at a UE. The apparatus may include one or more memories storing processor-executable code and one or more processors coupled to the one or more memories. The one or more processors may be configured to receive offset information associated with a minimum offset between a scheduling grant and a corresponding PUSCH communication. The one or more processors may be configured to cause the UE to transmit an indication of an unused TO based at least in part on a time duration between an uplink TO for the indication and the unused TO being equal to or greater than the minimum offset. In some aspects, the one or more processors may be individually or collectively configured to perform the operations.

Some aspects described herein relate to an apparatus for wireless communication at a network entity. The apparatus may include one or more memories storing processor-executable code and one or more processors coupled to the one or more memories. The one or more processors may be configured to generate offset information associated with a minimum offset between a scheduling grant and a corresponding PUSCH communication and associated with an indication of an unused TO. The one or more processors may be configured to cause the network entity to transmit the offset information. In some aspects, the one or more processors may be individually or collectively configured to perform the operations.

Some aspects described herein relate to a non-transitory computer-readable medium that stores a set of instructions for wireless communication by a UE. The set of instructions, when executed by one or more processors of the UE, may cause the UE to receive offset information associated with a minimum offset between a scheduling grant and a corresponding PUSCH communication. The set of instructions, when executed by one or more processors of the UE, may cause the UE to transmit an indication of an unused TO based at least in part on a time duration between an uplink TO for the indication and the unused TO being equal to or greater than the minimum offset.

Some aspects described herein relate to a non-transitory computer-readable medium that stores a set of instructions for wireless communication by a network entity. The set of instructions, when executed by one or more processors of the network entity, may cause the network entity to generate offset information associated with a minimum offset between a scheduling grant and a corresponding PUSCH communication and associated with a UE determining to transmit an indication of an unused TO. The set of instructions, when executed by one or more processors of the network entity, may cause the network entity to transmit the offset information.

Some aspects described herein relate to an apparatus for wireless communication. The apparatus may include means for receiving offset information associated with a minimum offset between a scheduling grant and a corresponding PUSCH communication. The apparatus may include means for transmitting an indication of an unused TO based at least in part on a time duration between an uplink TO for the indication and the unused TO being equal to or greater than the minimum offset.

Some aspects described herein relate to an apparatus for wireless communication. The apparatus may include means for generating offset information associated with a minimum offset between a scheduling grant and a corresponding PUSCH communication and associated with another apparatus determining to transmit an indication of an unused TO. The apparatus may include means for transmitting the offset information.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of uplink configured grant (CG) communication, in accordance with the present disclosure.

FIG. 5 is a diagram illustrating an example of unused transmission occasions (TOs), in accordance with the present disclosure.

FIG. 6 is a diagram illustrating an example of indicating unused TOs, in accordance with the present disclosure.

FIG. 7 is a diagram illustrating examples of timelines for an indication of an unused TO, in accordance with the present disclosure.

FIG. 8 is a diagram illustrating an example associated with offset information for indicating an unused TO, in accordance with the present disclosure.

FIG. 9 is a diagram illustrating an example of updated offset information and updated thresholds, in accordance with the present disclosure.

FIG. 10 is a diagram illustrating an example process performed, for example, by a UE, in accordance with the present disclosure.

FIG. 11 is a diagram illustrating an example process performed, for example, by a network entity, in accordance with the present disclosure.

FIG. 12 is a diagram of an example apparatus for wireless communication, in accordance with the present disclosure.

FIG. 13 is a diagram illustrating an example of an implementation of code and circuitry for an apparatus, in accordance with the present disclosure.

FIG. 14 is a diagram illustrating an example of a hardware implementation for an apparatus employing a processing system, in accordance with the present disclosure.

FIG. 15 is a diagram of an example apparatus for wireless communication, in accordance with the present disclosure.

FIG. 16 is a diagram illustrating an example of a hardware implementation for an apparatus employing a processing system, in accordance with the present disclosure.

FIG. 17 is a diagram illustrating an example of an implementation of code and circuitry for an apparatus, in accordance with the present disclosure.

### DETAILED DESCRIPTION

In some examples, a resource for uplink communications by a user equipment (UE) may be granted by a configuration. Such a resource may be referred to as a “configured grant” (CG). For example, physical uplink shared channel (PUSCH) communications in CG grants (also referred to as CG-PUSCH transmission occasions (TOs)) may include periodic uplink communications, such that a network entity does not need to send separate downlink control information (DCI) to schedule each uplink communication, thereby conserving signaling overhead. With CG scheduling, more resources may be allocated than what is necessary for the transmission of uplink communications. In some examples, the UE may skip one or more TOs to conserve power. If one or more TOs are skipped (“unused”), the UE may indicate, in uplink control information (UCI), the one or more TOs that are unused. TOs that are not skipped and can be used are considered to be “not unused.” According to one more examples, this is because unskipped resources are not always used.

In an example, another UE may or may not be able to use an unused TO. A UE expects to have a certain amount of time to process a scheduling grant from a network entity and prepare to use the scheduling grant for an uplink transmission. This amount of time may be referred to as an offset (or K2). If the other UE is to use an unused TO, the time duration (e.g., D) between the uplink slot (in which UCI indicates an unused TO) and the actual unused TO may not be shorter in time than K2. If K2 is equal to or greater than D, there is not enough time to reallocate the unused TO to another UE. As such, the indication in UCI would be a waste of signaling resources. If K2 is less than D, there is sufficient time to reallocate the unused TO. That is, the indication in UCI will be early enough in time for the network entity to reallocate the unused TO to another UE. The use of a reallocation of resources conserves signaling resources and reduces latency. However, the UE may not have information about whether an indication of an unused TO would be received in time such that the unused TO can be used by another UE. Without this information, signaling resources could be wasted.

According to various aspects described herein, a network entity may provide, to a UE, offset information that is associated with a minimum offset for K2 that would provide sufficient time to reallocate an unused TO. K2 corresponds to a capability of a UE to process and use a scheduling grant, however, in one or more examples, there may be multiple UEs with different capabilities or K2s. The minimum offset for K2 may include the minimum value or amount of time for K2, for comparison to the time duration (e.g., D) between the uplink slot (in which UCI indicates an unused TO) and the actual unused TO. In some aspects, the offset information may indicate a minimum offset for K2. In some aspects, the offset information from the network entity to the UE may include multiple offset candidates (e.g., a K2 candidate for each UE), and the UE may select the offset candidate for K2 from among the multiple offset candidates. If the network entity provides, to the UE, offset information for a minimum offset for K2, the UE may determine that K2 is greater than the minimum offset and not transmit an indication of an unused TO. If K2 is less than or equal to D, the UE may transmit the indication of the unused TO, as another UE can use the unused TO because there is enough time for the network entity to schedule the other UE to use the unused TO. In this way, signaling resources are conserved if an unused TO can be reallocated to another UE, and signaling resources may not be wasted by sending an indication of an unused TO that will not be used.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

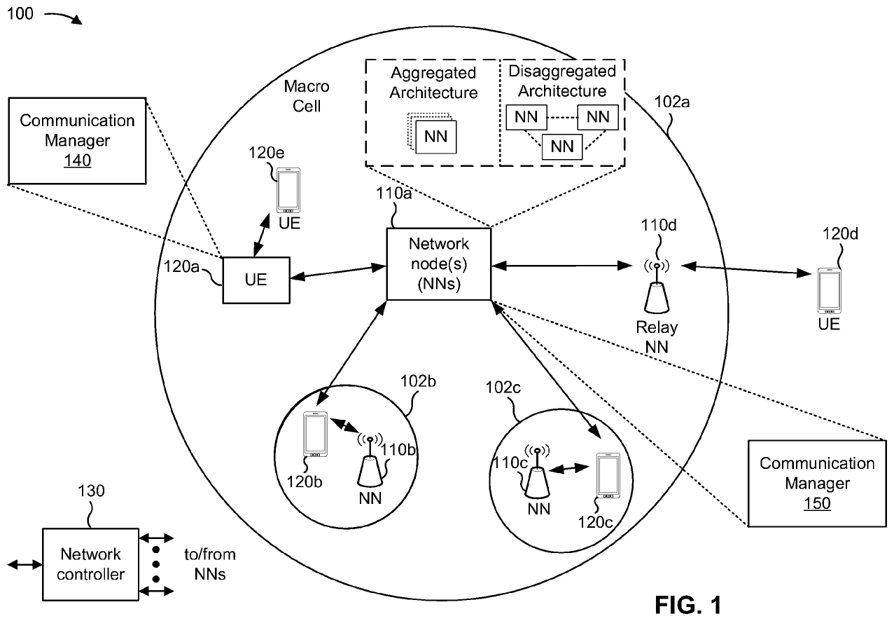

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR 1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive offset information associated with a minimum offset between a scheduling grant and a corresponding PUSCH communication. The communication manager 140 may transmit an indication of an unused TO based at least in part on a time duration between an uplink TO for the indication and the unused TO being equal to or greater than the minimum offset. Additionally, or alternatively, the communication manager 140 may perform one or more other operations described herein.

In some aspects, a network entity (e.g., a network node 110) may include a communication manager 150. As described in more detail elsewhere herein, the communication manager 150 may generate offset information associated with a minimum offset between a scheduling grant and a corresponding PUSCH communication and associated with a UE determining to transmit an indication of an unused TO. The communication manager 150 may transmit the offset information. Additionally, or alternatively, the communication manager 150 may perform one or more other operations described herein.

As indicated above, FIG. 1 is provided as an example. Other examples may differ from what is described with regard to FIG. 1.

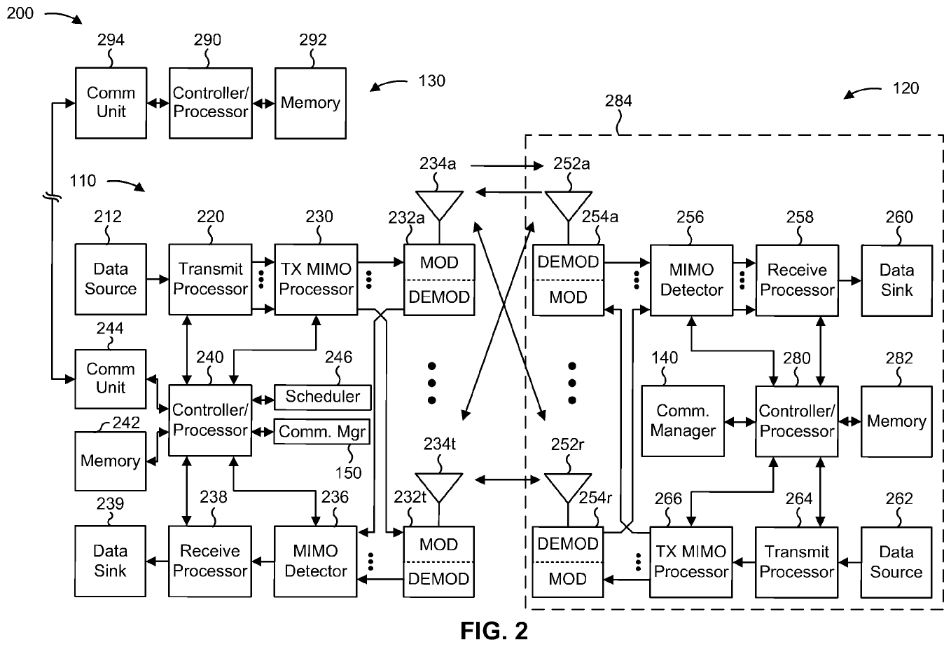

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

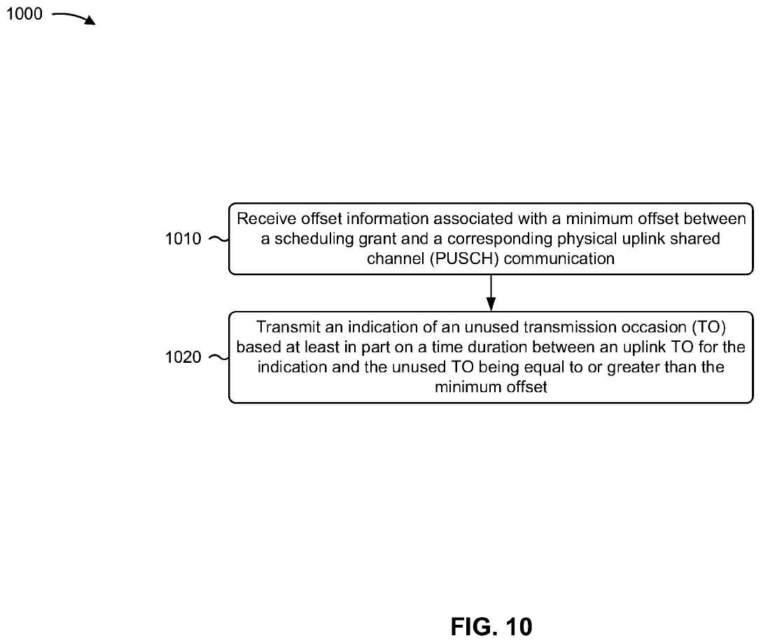

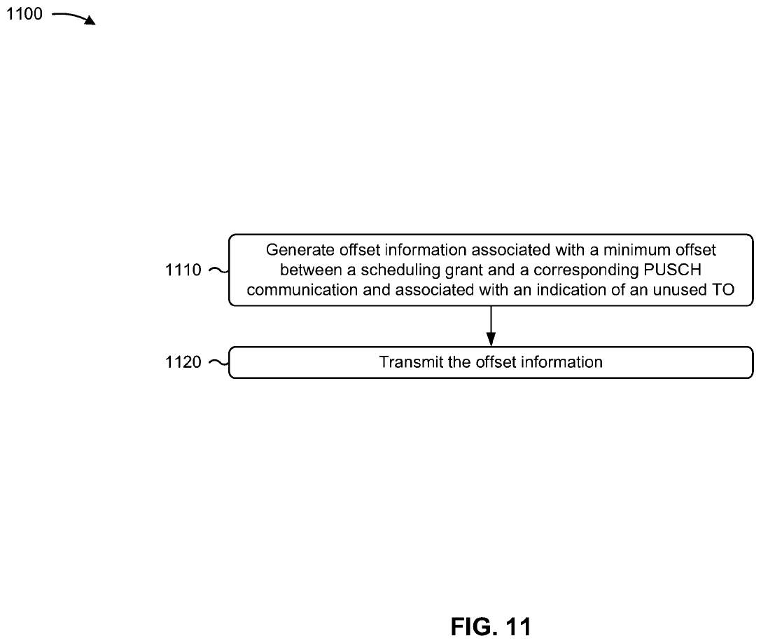

A controller/processor of a network entity (e.g., controller/processor 240 of the network node 110), the controller/processor 280 of the UE 120, and/or any other component(s) of FIG. 2 may perform one or more techniques associated with a minimum offset value for an indication of an unused TO, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving offset information associated with a minimum offset between a scheduling grant and a corresponding PUSCH communication; and/or means for transmitting an indication of an unused TO based at least in part on a time duration between an uplink TO for the indication and the unused TO being equal to or greater than the minimum offset. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network entity) includes means for generating offset information associated with a minimum offset between a scheduling grant and a corresponding PUSCH communication and associated with a UE determining to transmit an indication of an unused TO; and/or means for transmitting the offset information. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

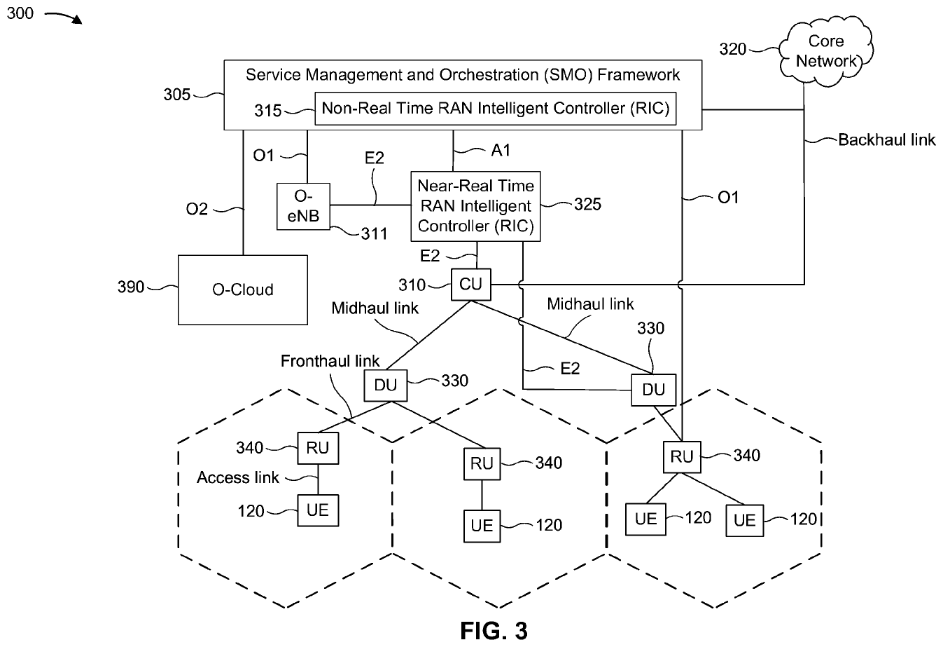

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

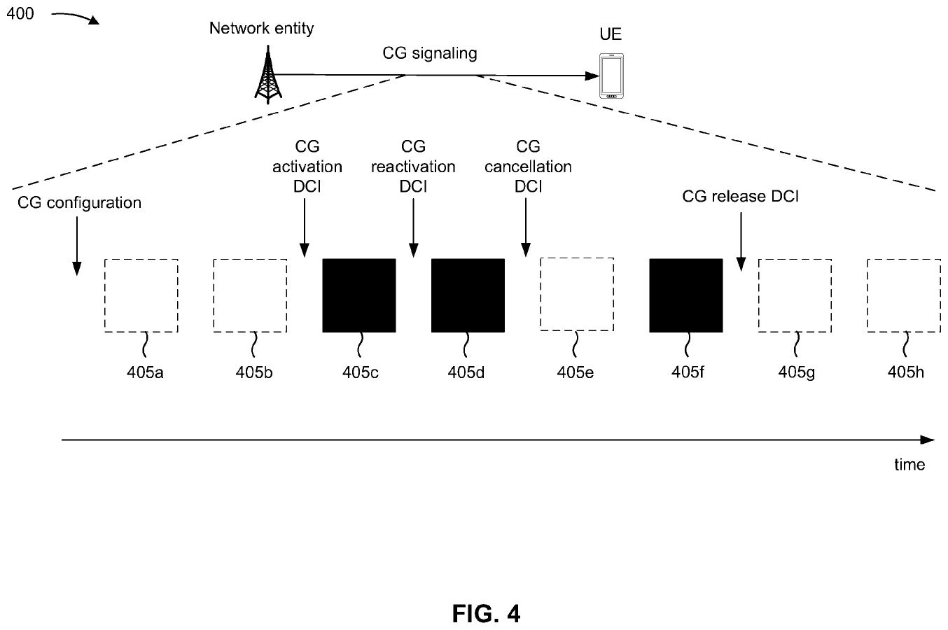

FIG. 4 is a diagram illustrating an example 400 of uplink CG communication, in accordance with the present disclosure.

In some aspects, physical resource blocks (PRBs) for uplink communications may be granted dynamically, such as with a scheduling request (SR) or a buffer status report (BSR). A UE may first transmit an SR on a physical uplink control channel (PUCCH), requesting radio resources in the uplink when the UE has pending data in its buffer. With periodic BSR reporting, the network entity knows the available buffer at the UE. The network entity then transmits an uplink grant DCI. The allocated resources are specified in the DCI for the UE to transmit a communication on the PUSCH.

Alternatively, PRBs for uplink communications may be granted according to a configuration. For example, CG communications may include periodic uplink communications that are configured for a UE, such that the network entity does not need to send separate DCI to schedule each uplink communication, thereby conserving signaling overhead.

As shown in example 400, a UE (e.g., UE 120) may be configured with a CG configuration for CG communications. For example, the UE may receive the CG configuration via an RRC message transmitted by a network entity (e.g., a network node 110). The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 405 for the UE. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The network entity may additionally transmit CG activation DCI to the UE to activate the CG configuration for the UE (e.g., for a Type 2 CG configuration). The network entity may indicate, in the CG activation DCI, communication parameters, such as an MCS, an RB allocation, and/or antenna ports, for the CG-PUSCH communications to be transmitted in the scheduled CG occasions 405 (405a through 405h). The UE may begin transmitting in the CG occasions 405 based at least in part on receiving the CG activation DCI. For example, beginning with a next scheduled CG occasion 405 subsequent to receiving the CG activation DCI, the UE may transmit a PUSCH communication in the scheduled CG occasions 405 using the communication parameters indicated in the CG activation DCI. The UE may refrain from transmitting in configured CG occasions 405 prior to receiving the CG activation DCI.

The network entity may transmit CG reactivation DCI to the UE to change the communication parameters for future CG-PUSCH communications. Based at least in part on receiving the CG reactivation DCI, the UE may begin transmitting in the scheduled CG occasions 405 using the communication parameters (e.g., MCS, an RB allocation, and/or antenna ports) indicated in the CG reactivation DCI. For example, beginning with a next scheduled CG occasion 405 subsequent to receiving the CG reactivation DCI, the UE may transmit the future PUSCH communications in the scheduled CG occasions 405 based at least in part on the communication parameters indicated in the CG reactivation DCI.

In some cases, such as when the network entity needs to override a scheduled CG communication for a higher priority communication, the network entity may transmit CG cancellation DCI to the UE to temporarily cancel or deactivate one or more subsequent CG occasions 405 for the UE. The CG cancellation DCI may deactivate only a subsequent one CG occasion 405 or a subsequent N CG occasions 405 (where N is an integer). CG occasions 405 after the one or more (e.g., N) CG occasions 405 subsequent to the CG cancellation DCI may remain activated. Based at least in part on receiving the CG cancellation DCI, the UE may refrain from transmitting in the one or more (e.g., N) CG occasions 405 subsequent to receiving the CG cancellation DCI. As shown in example 400, the CG cancellation DCI cancels one subsequent CG occasion 405 for the UE. After the CG occasion 405 (or N CG occasions) subsequent to receiving the CG cancellation DCI, the UE may automatically resume transmission in the scheduled CG occasions 405.

The network entity may transmit CG release DCI to the UE to deactivate the CG configuration for the UE. The UE may stop transmitting in the scheduled CG occasions 405 based at least in part on receiving the CG release DCI. For example, the UE may refrain from transmitting in any scheduled CG occasions 405 until another CG activation DCI is received from the network entity. Whereas the CG cancellation DCI may deactivate only a subsequent one CG occasion 405 or a subsequent N CG occasions 405, the CG release DCI deactivates all subsequent CG occasions 405 for a given CG configuration for the UE until the given CG configuration is activated again by a new CG activation DCI.

As indicated above, FIG. 4 is provided as an example. Other examples may differ from what is described with respect to FIG. 4.

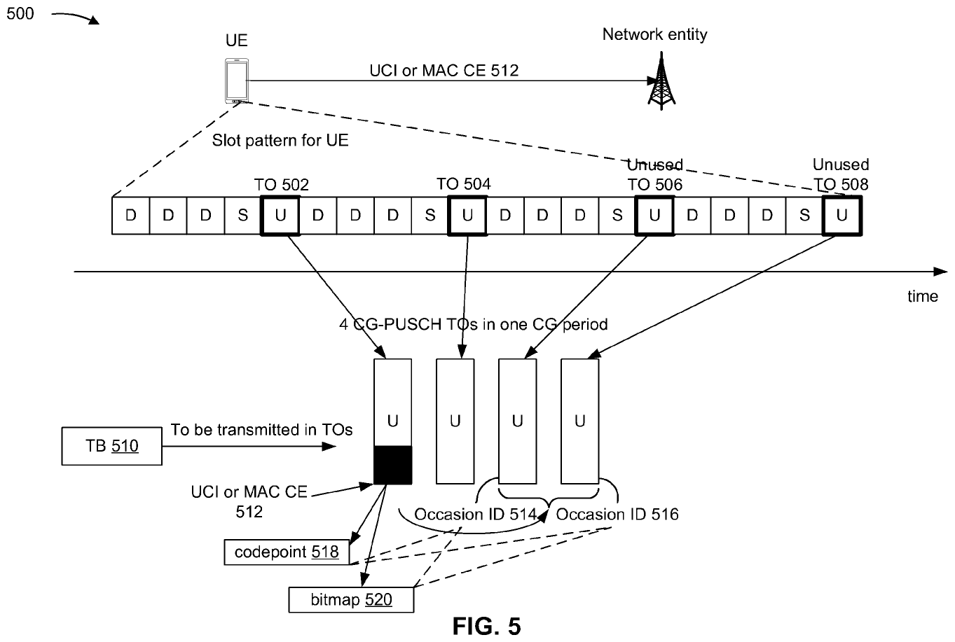

FIG. 5 is a diagram illustrating an example 500 of unused TOs, in accordance with the present disclosure.

In an example, CG-PUSCH scheduling may work well for traffic with a stringent latency expectation, such as XR gaming traffic, cloud gaming traffic, etc.

According to one aspect, the network entity (e.g., gNB) may assign multiple CG-PUSCH occasions (also referred to herein as “CG occasions” or “transmission occasions” (TOs)) for one UE for upcoming PUSCH data, including for large and variable XR video frames. Example 500 shows a slot pattern with uplink (U) slots that are scheduled (allocated) CG-PUSCH TOs for the UE, such as TO 502, TO 504, TO 506, and TO 508. TO 502, TO 504, TO 506, and TO 508 may be part of a CG period. Because no SR and BSR are required before a PUSCH data transmission, the network entity may not know the accurate uplink payload size (e.g., for transport block (TB) 510) and how many CG-PUSCH TOs are to be used by the UE for the PUSCH transmission. There may be a mismatch between the allocated TOs 502-508 and the expected resources needed for transmitting the TB 510. If the allocated TOs 502-508 are too few for the upcoming TB 510, more resources are to be used by the UE and latency will be increased. If the allocated TOs 502-508 are too many for the upcoming TB 510, some TOs will be wasted.

If one or more CG-PUSCH TOs are skipped, the UE may indicate, in UCI (or a medium access control control element (MAC CE)) 512, the one or more TOs that are skipped (e.g., TO 506 and TO 508). When an uplink XR video frame arrives for transmission from the upper layers at the UE, the UE may know the video frame size and thus the number of TOs needed to transmit the video frame. The UE may determine how many TOs are to be skipped. TOs that are skipped may be considered to be “unused” and thus TO 506 and TO 508 are shown in FIG. 5 as unused TO 506 and unused TO 508. TOs that are not skipped and can be used are considered to be “not unused.” Because TOs that are not unused may still not be used (due to traffic or scheduling reasons), the TOs may not be definitely “used”. Therefore, such TOs that are not unused may be considered to be “not unused.” That is, TOs that are “not unused” may or may not be used. Accordingly, UCI may indicate which TOs are used and which TOs are not unused. The indication of unused TOs to the network entity may reduce blind detection by the network entity and allow the network entity to reallocate unused PUSCH resources. According to one or more examples, UCI may explicitly indicate TOs that are not unused, and the TOs that are unused can be derived (unused TOs are the TOs that remain after removing the TOs that are not unused). Similarly, UCI may explicitly indicate TOs that are unused and the TOs that are not unused can be derived (not unused TOs are the TOs that remain after removing the TOs that are unused). In sum, there may be different ways for the UE to indicate which TOs are used and which TOs are not unused.

It should be noted that, in one or more examples, a “not unused” TO may also be called a “used” TO. In either case, the UE is allowed to not transmit a PUSCH communication if there is no uplink data to be sent. The indication of “used” TOs (e.g., UCI or MAC 512) may help the network entity to reduce blind detection efforts for overlapping TOs.

If there are to be unused TOs, the UE can indicate the unused TOs to a network entity via a UCI or a MAC CE 502. For example, the UCI or MAC CE 502 may indicate unused TO 504 and unused TO 506. Each TO may be identified with a CG occasion ID (e.g., index or other identifier). In some aspects, UCI that indicates unused TOs (e.g. for XR traffic) may be legacy CG-UCI or a new UCI. UCI may indicate a TO that is the last not unused TO or a TO that is the first of multiple consecutive unused TOs. UCI may indicate that multiple consecutive TOs, based on a start occasion and a length, are unused (occasion ID numbering may or may not be consecutive). UCI may include a bit in a bitmap that indicates whether a TO is unused, if a location of the bit in the bitmap is mapped to the occasion ID of the configured TO. UCI may include a codepoint value that indicates that one or multiple TOs are unused, if the value is mapped to the occasion ID(s). Example 500 shows that unused TO 506 may have an occasion ID 514 and unused TO 508 may have an occasion ID 516. In some aspects, a codepoint 518 or a bitmap 520 in the UCI or MAC CE 512 may map to the occasion ID 514 and the occasion ID 516.

As indicated above, FIG. 5 is provided as an example. Other examples may differ from what is described with regard to FIG. 5.

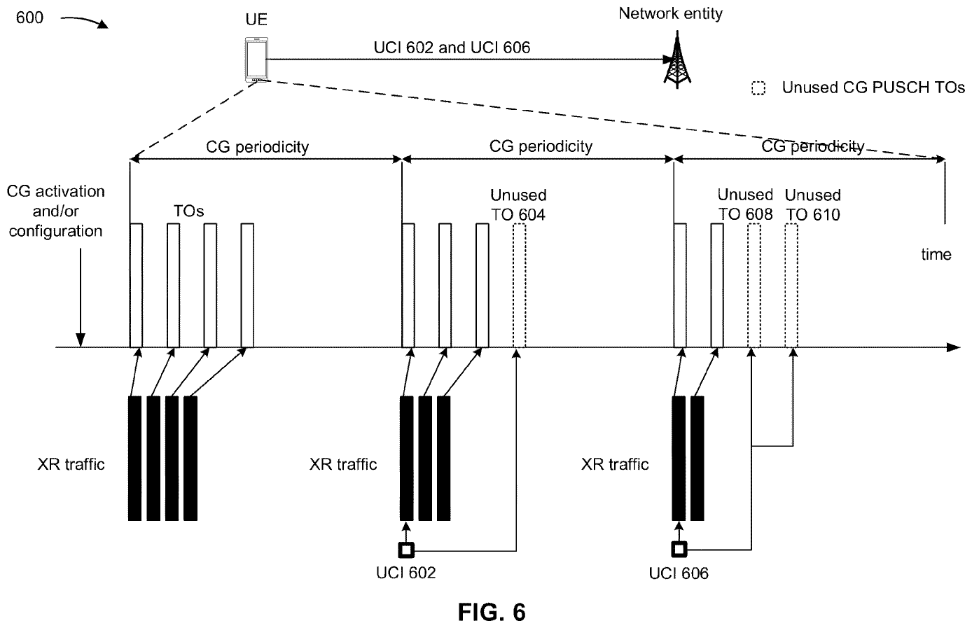

FIG. 6 is a diagram illustrating an example 600 of indicating unused TOs, in accordance with the present disclosure.

Example 600 shows multiple CG periods in which XR traffic is to be transmitted. In a first CG period, the XR traffic may use all of the allocated TOs. In a second CG period, the XR traffic may not use all of the allocated TOs. UCI 602 may indicate unused TO 604. In a third CG period, the XR traffic may use only half of the TOs, and UCI 606 may indicate unused TO 608 and unused TO 610. The network entity may receive the UCI and reallocate unused TO 608 and unused TO 610 to another UE to avoid wasting the resources.

As indicated above, FIG. 6 is provided as an example. Other examples may differ from what is described with regard to FIG. 6.

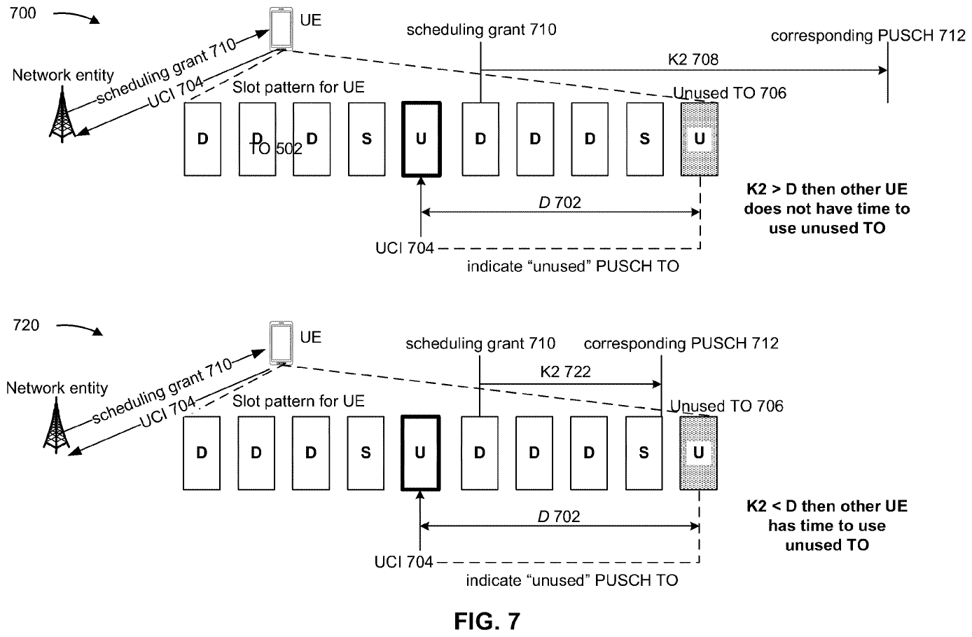

FIG. 7 is a diagram illustrating examples 700 and 720 of timelines for an indication of an unused TO, in accordance with the present disclosure.

Example 700 shows an uplink slot for a UCI that indicates an unused TO. There is a time duration (shown by D 702) between the uplink slot in which UCI 704 indicates an unused TO 706. There is also an offset (shown as K2 708) between a scheduling grant 710 and a corresponding PUSCH 712 scheduled by the grant 710. If K2 708 is equal to or greater than D 702, as shown by example 700, there is not enough time to reallocate unused TO 706. The indication in UCI 704 would be a waste of signaling resources. If K2 708 is less than D 702, as shown by example 720, there is sufficient time to reallocate unused TO 706. The indication in UCI 704 is in time for the network entity to reallocate unused TO 706 to another UE, which conserves signaling resources and reduces latency. Note that a determination may be based at least in part on K2 708 being equal to or greater than D 702 or just K2 708 being greater than D 702. Correspondingly, a determination may be based at least in part on K2 708 just being less than D 702 or being less than or equal to D 702. In any event, the UE does not have information about whether an indication of an unused TO would be beneficial or a waste of signaling resources.

According to various aspects described herein, a network entity may provide, to a UE, offset information that is associated with a minimum offset for K2 708 that would provide sufficient time to reallocate an unused TO. In some aspects, the offset information may indicate a minimum offset for K2 708. In some aspects, the offset information may include multiple offset candidates (e.g., a K2 candidate for each UE), and the UE may select the offset candidate for K2 708 from among the multiple offset candidates. If the network entity provides offset information for a minimum offset for K2, the UE may determine that K2 708 is greater than the minimum offset and not transmit an indication of an unused TO. If K2 708 is less than or equal to D 702, the UE may transmit the indication of the unused TO. In this way, signaling resources are conserved if an unused TO can be reallocated to another UE, and signaling resources may not be wasted by sending an indication of an unused TO that will not be used.

As indicated above, FIG. 7 is provided as an example. Other examples may differ from what is described with regard to FIG. 7.

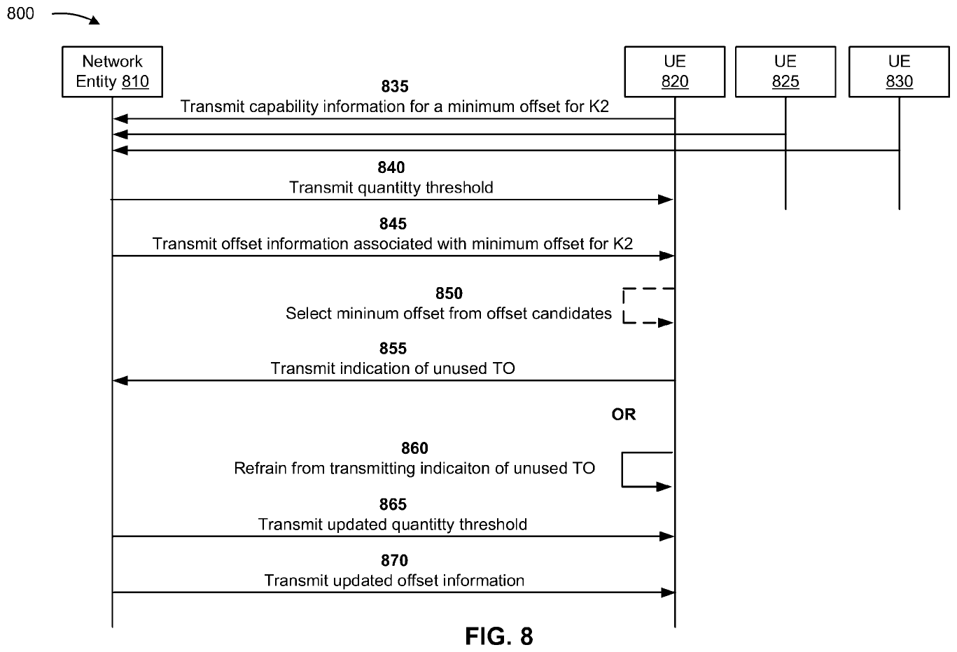

FIG. 8 is a diagram illustrating an example 800 associated with offset information for indicating an unused TO, in accordance with the present disclosure. As shown in FIG. 8, a network entity 810 (e.g., a network node 110) and a UE 820 (e.g., a UE 120) may communicate with one another via a wireless network (e.g., wireless network 100). The network entity 810 may also communicate with UE 825 and UE 830.

As shown by reference number 835, UE 820, UE 825, and UE 830 may transmit capability information for a minimum offset for K2 (time between a scheduling grant and a corresponding PUSCH communication). That is, the capability information for a respective UE may indicate an offset capability by which the network entity 810 can determine a minimum offset for K2 for the UE. The offset capability may indicate a minimum offset for K2 or parameters for deriving the minimum offset. The network entity 810 may receive the capability information from the multiple UEs. Each UE (e.g., UE 825, UE 830) may have different capabilities and thus different minimum offsets. If no other UE has a minimum offset that will allow for reallocating an unused TO, then there may be no benefit in UE 820 transmitting an indication of an unused TO to the network entity 810. However, if there is at least one other UE (e.g., UE 830) with a minimum offset for K2 that will allow for reallocating an unused TO, then there is a benefit in UE 820 transmitting an indication of an unused TO to the network entity 810. The network entity 810 may schedule UE 830 to use the unused TO of UE 820.

In some aspects, as shown by reference number 840, the network entity 810 may transmit a quantity threshold. The network entity 810 may transmit the quantity threshold in an RRC message. The quantity threshold may include a quantity of UEs that satisfy a threshold for a minimum offset for K2. For example, if there are too few UEs that satisfy the threshold for the minimum offset, the probability that another UE can use an unused TO may be low and it may be a waste of signaling resources to indicate the unused TO. If there are many UEs that could use the unused TO (satisfy the threshold for the minimum offset), an indication of the unused TO would not be a waste of signaling resources, as there is a high probability that the unused TO would be reallocated to another UE. The network entity 810 may transmit the quantity threshold in a MAC CE. The network entity 810 may transmit the quantity threshold in DCI.

As shown by reference number 845, the network entity 810 may transmit offset information that is associated with a minimum offset for K2. The network entity 810 may transmit the offset information in an RRC message. The network entity 810 may transmit the offset information in a MAC CE. The network entity 810 may transmit the offset information in DCI. The network entity 810 may transmit the offset information when the network entity 810 configures the UE 820 for multiple PUSCH communications. The offset information may be associated with a configuration for the PUSCH configured grant.

In some aspects, the offset information may indicate the minimum offset for K2. Alternatively, in some aspects, the offset information may include multiple offset candidates for multiple UEs. For example, the offset information may include multiple K2 candidates, where each K2 candidate is for a UE of the multiple UEs. As shown by reference number 850, if the offset information includes multiple offset candidates, the UE 820 may select the minimum offset for K2 from the offset candidates. For example, the UE 820 may select a maximum of the offset candidates to be the minimum offset for K2. The UE 820 may select a minimum of the offset candidates to be the minimum offset for K2. The UE 820 may select an average of the offset candidates to be the minimum offset for K2.

UE 820 may determine that a future TO is to be unused. This determination may be based at least in part on the amount of traffic to be transmitted, traffic conditions, channel conditions, and/or a status of the UE 820. In some aspects, the UE 820 may transmit the indication of the unused TO based at least in part on a time duration (e.g., D) between the uplink TO used for the indication and the unused TO being equal to or greater than the minimum offset (e.g., K2). As shown by reference number 855, the UE 820 may transmit the indication of an unused TO if K2 is less than or equal to D. Alternatively, as shown by reference number 860, the UE 820 may refrain from transmitting an indication of the unused TO if K2 is greater than D.

In some aspects, the UE 820 may transmit the indication of the unused TO further based at least in part on a quantity of UEs satisfying a quantity threshold. The quantity of UEs may be based at least in part on UEs that meet another threshold (e.g., minimum offset capability, K2 for the UE less than D). If the quantity of UEs satisfies the quantity threshold (e.g., quantity of UEs equal to or greater than the quantity threshold), the UE 820 may transmit the indication of the unused TO (or of multiple unused TOs). If the quantity of UEs does not satisfy the quantity threshold, the UE 820 may refrain from transmitting the indication of the unused TO. By using offset information that is informed by the capabilities of other UEs, the UE 820 may not transmit an indication of an unused TO that would not be used. As a result, signaling resources are conserved.

In some aspects, the network entity 810 may indicate offset candidates to the UE 820 with RRC signaling when the network entity 810 configures the UE 820 for multi-PUSCH CG, and the quantity threshold may be preconfigured with DCI. In some aspects, for type 2 CG-PUSCH scheduling (RRC configures the periodicity of the CG), the network entity 810 may indicate offset candidates to the UE 820 with a MAC CE when the network entity 810 triggers the UE 820 for multi-PUSCH CG, and the quantity threshold may be preconfigured with a MAC CE or DCI. In some aspects, for type 2 CG-PUSCH scheduling, the network entity 810 may indicate the minimum offset for K2 to the UE 820 with a MAC CE or DCI when the network entity 810 triggers the UE 820 for multi-PUSCH CG.

As shown by reference number 865, the network entity 810 may transmit an updated quantity threshold (e.g., via RRC signaling). The update quantity threshold may include a quantity of UEs that is more or fewer than an existing quantity threshold. As shown by reference number 870, the network entity 810 may transmit updated offset information. The updated offset information may indicate a new minimum offset for K2 or different offset candidates for the minimum offset.

As indicated above, FIG. 8 is provided as an example. Other examples may differ from what is described with regard to FIG. 8.

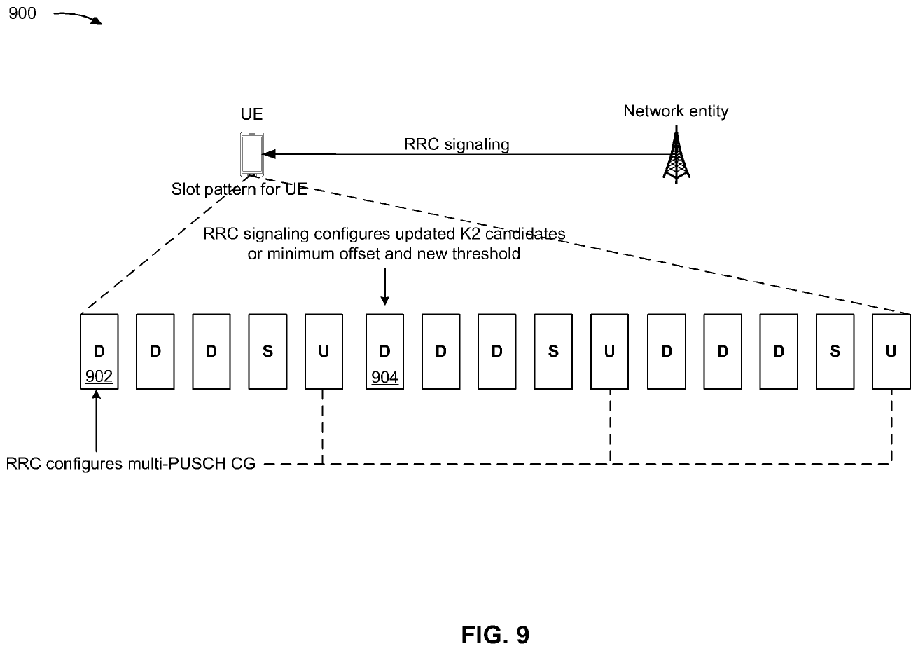

FIG. 9 is a diagram illustrating an example 900 of updated offset information and updated thresholds, in accordance with the present disclosure.

If more UEs are attached to the cell, more K2 candidates will appear. In some aspects, the network entity 810 may transmit updated offset information to the UE 820 in intermediate downlink slots. For example, the network entity 810 may configure the UE 820 with offset information and a quantity threshold at downlink slot 902. The offset information may include updated K2 candidates. The offset information may indicate an updated minimum offset for K2.

At downlink slot 904, the network entity 810 may transmit updated offset information (e.g., K2 candidates, minimum offset) to the UE 820 via RRC signaling.

The network entity 810 may also transmit an updated quantity threshold to the UE 820 (e.g., via RRC signaling) to override the formerly configured quantity threshold.

In some aspects, the network entity 810 may transmit updated offset information to the UE 820 via a MAC CE. The network entity 810 may also transmit an updated quantity threshold to the UE 820 via a MAC CE or DCI in intermediate downlink slots.

In some aspects, the network entity 810 may transmit offset information and/or updated offset information in a wake up signal (WUS). The WUS may be a low power WUS that is intended to be received by a low power radio that uses less power than a main radio and/or that operates in a power saving mode. The WUS may wake up the UE 820 such that the UE 820 uses more radio components or operates a main radio. In some aspects, the network entity 810 may transmit a quantity threshold and/or an updated quantity threshold in a WUS.

In some aspects, the network entity 810 may transmit to or configure the UE 820 with multiple K2 candidates (e.g., via RRC signaling, a MAC CE, or DCI) that have corresponding indices (e.g., in an index table). The network entity 810 may transmit an index for one of the multiple K2 candidates to be used as the minimum offset for K2. The network entity 810 may transmit the index in a WUS. For example, an index of 1 may indicate that the minimum offset for K2 will be the offset of a first K2 candidate for a first UE, an index of 2 may indicate that the minimum offset for K2 will be the offset of a second K2 candidate for a second UE, an index of 3 may indicate that the minimum offset for K2 will be the offset of a third K2 candidate for a third UE, and so forth.

In some aspects, the network entity 810 may transmit to or configure the UE 820 with multiple K2 candidates and a corresponding quantity of UEs (e.g., via RRC signaling, a MAC CE, DCI, a low power WUS). The K2 candidate values and the quantity of UEs with the same K2 value may be stored in a data structure, such as an index table. The network entity 810 may transmit an index for one of the multiple K2 candidates to be used as the minimum offset for K2. At any point in time, the network entity 810 may have accurate information about the K2 value of all attached UEs and how many UEs are with the same K2 value.

The network entity 810 may transmit an indication whether to increment or decrement the quantity of UEs for a K2 value. The network entity 810 may indicate the instant changes of the quantity of UEs with the same K2 value via a MAC CE, DCI, or a low power WUS. For example, if one more UEs attach to the network entity 810 and its K2 value is K2_0, then the network entity 810 indicates X=X+1. If one UE with K2_0 is handed over to another cell, the network entity 810 indicates X=X−1.

In some aspects, the network entity 810 indicates the offset information (e.g., minimum offset for K2, multiple K2 values) and/or a quantity threshold to multiple or all UEs with a multicast or broadcast mode. The network entity 810 may multicast or broadcast the offset information and/or quantity threshold periodically to ensure that the K2 values are updated regularly. The multicast or broadcast may conserve signaling resources and time as compared to indicating the offset information and/or quantity threshold to each UE individually. The network entity 810 may use a common DCI (with a specific radio network temporary identifier (RNTI)) for multicast or broadcast.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120, UE 820) performs operations associated with a minimum offset value for an indication of an unused TO.

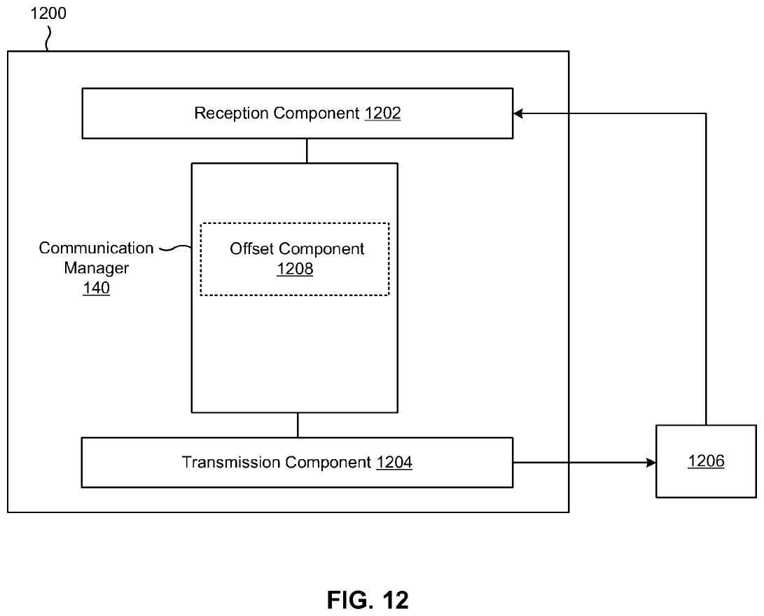

As shown in FIG. 10, in some aspects, process 1000 may include receiving offset information associated with a minimum offset between a scheduling grant and a corresponding PUSCH communication (block 1010). For example, the UE (e.g., using communication manager 140 and/or reception component 1202, depicted in FIG. 12) may receive offset information associated with a minimum offset between a scheduling grant and a corresponding PUSCH communication, as described above.

As further shown in FIG. 10, in some aspects, process 1000 may include transmitting an indication of an unused TO based at least in part on a time duration between an uplink TO for the indication and the unused TO being equal to or greater than the minimum offset (block 1020). For example, the UE (e.g., using communication manager 140 and/or transmission component 1204, depicted in FIG. 12) may transmit an indication of an unused TO based at least in part on a time duration between an uplink TO for the indication and the unused TO being equal to or greater than the minimum offset, as described above.

Process 1000 may include additional aspects, such as any single aspect or any combination of aspects described below and/or in connection with one or more other processes described elsewhere herein.

In a first aspect, process 1000 includes transmitting capability information that indicates an offset capability of the UE.

In a second aspect, alone or in combination with the first aspect, the offset information indicates the minimum offset.

In a third aspect, alone or in combination with one or more of the first and second aspects, receiving the offset information includes receiving the offset information in an RRC message.

In a fourth aspect, alone or in combination with one or more of the first through third aspects, the offset information is associated with a configuration for PUSCH configured grant.

In a fifth aspect, alone or in combination with one or more of the first through fourth aspects, receiving the offset information includes receiving the offset information in DCI or a MAC CE that is associated with PUSCH configured grant.

In a sixth aspect, alone or in combination with one or more of the first through fifth aspects, the offset information includes a quantity of offset candidates associated with multiple UEs, and process 1000 includes selecting the minimum offset from among the offset candidates.

In a seventh aspect, alone or in combination with one or more of the first through sixth aspects, transmitting the indication of the unused TO includes transmitting the indication of the unused TO further based at least in part on the quantity of offset candidates satisfying a quantity threshold.

In an eighth aspect, alone or in combination with one or more of the first through seventh aspects, process 1000 includes receiving the quantity threshold via a first DCI or a first MAC CE.

In a ninth aspect, alone or in combination with one or more of the first through eighth aspects, process 1000 includes receiving an updated quantity threshold via a second DCI or a second MAC CE.

In a tenth aspect, alone or in combination with one or more of the first through ninth aspects, process 1000 includes receiving the quantity threshold via a first RRC message.

In an eleventh aspect, alone or in combination with one or more of the first through tenth aspects, process 1000 includes receiving an updated quantity threshold via a second RRC message.

In a twelfth aspect, alone or in combination with one or more of the first through eleventh aspects, process 1000 includes receiving updated offset information that includes an updated quantity of offset candidates.

In a thirteenth aspect, alone or in combination with one or more of the first through twelfth aspects, process 1000 includes receiving updated offset information that indicates an updated minimum offset.

In a fourteenth aspect, alone or in combination with one or more of the first through thirteenth aspects, receiving the offset information includes receiving the offset information in a WUS.

In a fifteenth aspect, alone or in combination with one or more of the first through fourteenth aspects, process 1000 includes receiving updated offset information in a WUS.

In a sixteenth aspect, alone or in combination with one or more of the first through fifteenth aspects, process 1000 includes receiving multiple offset candidates with corresponding indices via an RRC message or a MAC CE, and receiving the offset information includes receiving a WUS that includes an index that corresponds to an offset candidate.

In a seventeenth aspect, alone or in combination with one or more of the first through sixteenth aspects, process 1000 includes receiving multiple offset candidates and a quantity of UEs for each offset candidate, and receiving a WUS that increments or decrements the quantity of UEs for an offset candidate.

In an eighteenth aspect, alone or in combination with one or more of the first through seventeenth aspects, receiving the offset information includes receiving the offset information in a broadcast or a multicast.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., network node 110, network entity 810) performs operations associated with a minimum offset value for an indication of an unused TO.

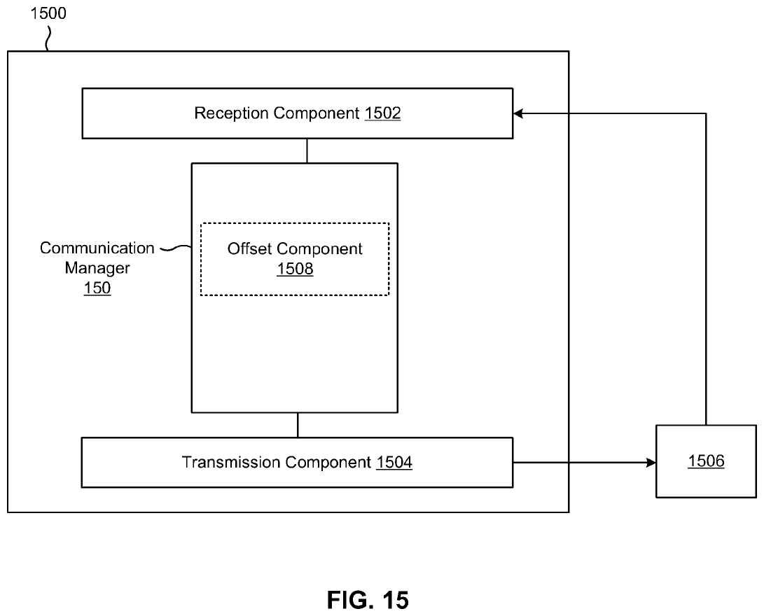

As shown in FIG. 11, in some aspects, process 1100 may include generating offset information associated with a minimum offset between a scheduling grant and a corresponding PUSCH communication and associated with a UE determining to transmit an indication of an unused TO (block 1110). For example, the network entity (e.g., using communication manager 150 and/or offset component 1508, depicted in FIG. 15) may generate offset information associated with a minimum offset between a scheduling grant and a corresponding PUSCH communication and associated with a UE determining to transmit an indication of an unused TO, as described above.

As further shown in FIG. 11, in some aspects, process 1100 may include transmitting the offset information (block 1120). For example, the network entity (e.g., using communication manager 150 and/or transmission component 1504, depicted in FIG. 15) may transmit the offset information, as described above.

Process 1100 may include additional aspects, such as any single aspect or any combination of aspects described below and/or in connection with one or more other processes described elsewhere herein.

In a first aspect, process 1100 includes receiving an indication of the unused TO.

In a second aspect, alone or in combination with the first aspect, process 1100 includes receiving, from each UE of multiple UEs, capability information that indicates an offset capability of the UE, and generating the offset information includes generating the offset information based at least in part on the capability information for each UE.

In a third aspect, alone or in combination with one or more of the first and second aspects, the offset information indicates the minimum offset.

In a fourth aspect, alone or in combination with one or more of the first through third aspects, the offset information includes a quantity of offset candidates associated with multiple UEs.

In a fifth aspect, alone or in combination with one or more of the first through fourth aspects, process 1100 includes transmitting a quantity threshold of UEs associated with transmission of a TO.

In a sixth aspect, alone or in combination with one or more of the first through fifth aspects, process 1100 includes transmitting an updated quantity threshold.

In a seventh aspect, alone or in combination with one or more of the first through sixth aspects, process 1100 includes transmitting updated offset information.

In an eighth aspect, alone or in combination with one or more of the first through seventh aspects, process 1100 includes transmitting multiple offset candidates with corresponding indices via an RRC message or a MAC CE, and transmitting the offset information includes transmitting a WUS that includes an index that corresponds to an offset candidate.

In a ninth aspect, alone or in combination with one or more of the first through eighth aspects, process 1100 includes transmitting multiple offset value candidates and a quantity of UEs for each offset candidate, and transmitting a WUS that increments or decrements the quantity of UEs for an offset candidate.

In a tenth aspect, alone or in combination with one or more of the first through ninth aspects, transmitting the offset information includes transmitting the offset information in a broadcast or a multicast.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE (e.g., UE 120, UE 820), or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include an offset component 1208, among other examples.

In some aspects, the apparatus 1200 may be configured to perform one or more operations described herein in connection with FIGS. 1-9. Additionally, or alternatively, the apparatus 1200 may be configured to perform one or more processes described herein, such as process 1000 of FIG. 10, process 1100 of FIG. 11, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive offset information associated with a minimum offset between a scheduling grant and a corresponding PUSCH communication. The transmission component 1204 may transmit an indication of an unused TO based at least in part on a time duration between an uplink TO for the indication and the unused TO being equal to or greater than the minimum offset. The offset component 1208 may compare the minimum offset and the time duration. The transmission component 1204 may transmit capability information that indicates an offset capability of the UE.

The reception component 1202 may receive the quantity threshold via a first DCI or a first MAC CE. The reception component 1202 may receive an updated quantity threshold via a second DCI or a second MAC CE. The reception component 1202 may receive the quantity threshold via a first RRC message. The reception component 1202 may receive an updated quantity threshold via a second RRC message.

The reception component 1202 may receive updated offset information that includes an updated quantity of offset candidates. The reception component 1202 may receive updated offset information that indicates an updated minimum offset. The reception component 1202 may receive updated offset information in a WUS.

The reception component 1202 may receive multiple offset candidates with corresponding indices via an RRC message or a MAC CE, and the reception component 1202 may receive a WUS that includes an index that corresponds to an offset candidate. The reception component 1202 may receive multiple offset candidates and a quantity of UEs for each offset candidate, and the reception component 1202 may receive a WUS that increments or decrements the quantity of UEs for an offset candidate.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

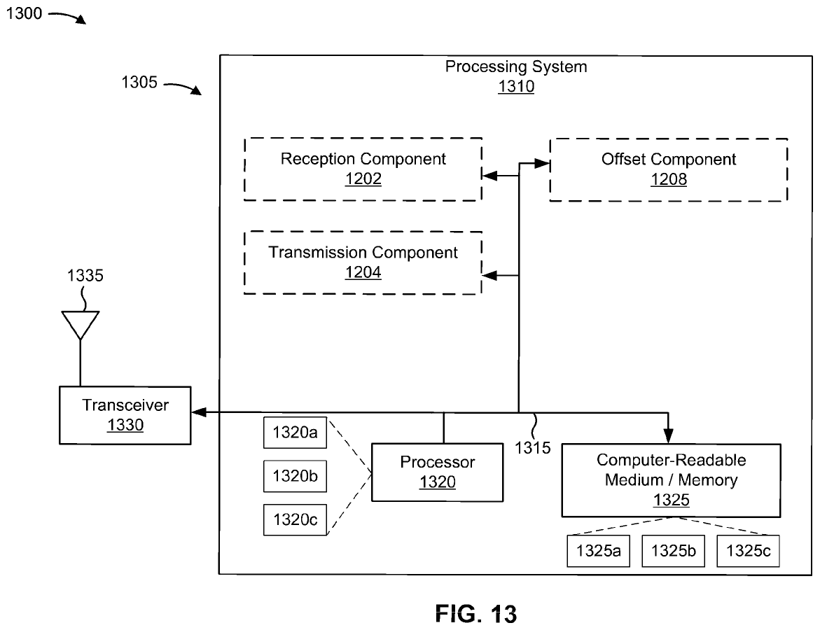

FIG. 13 is a diagram illustrating an example 1300 of a hardware implementation for an apparatus 1305 employing a processing system 1310, in accordance with the present disclosure. The apparatus 1305 may be a network entity.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor (or processing circuitry) 1320, the illustrated components, and the computer-readable medium/memory (or memory circuitry) 1325. The processor 1320 may include multiple processors, such as processor 1320a, memory 1320b, and memory 1320c. The memory 1325 may include multiple memories, such as memory 1325a, memory 1325b, and memory 1325c. The bus 1315 may also link various other circuits, such as timing sources, peripherals, voltage regulators, and/or power management circuits.

The processing system 1310 may be coupled to a transceiver 1330. The transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes a processor 1320 coupled to a computer-readable medium/memory 1325. The processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the UE 120 and may include the memory 282 and/or at least one of the TX MIMO processor 266, the RX processor 258, and/or the controller/processor 280. In some aspects, the apparatus 1305 for wireless communication includes means receiving offset information associated with a minimum offset between a scheduling grant and a corresponding PUSCH communication. In some aspects, the apparatus 1305 for wireless communication includes means transmitting an indication of an unused TO based at least in part on a time duration between an uplink TO for the indication and the unused TO being equal to or greater than the minimum offset. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 13 is provided as an example. Other examples may differ from what is described in connection with FIG. 13.

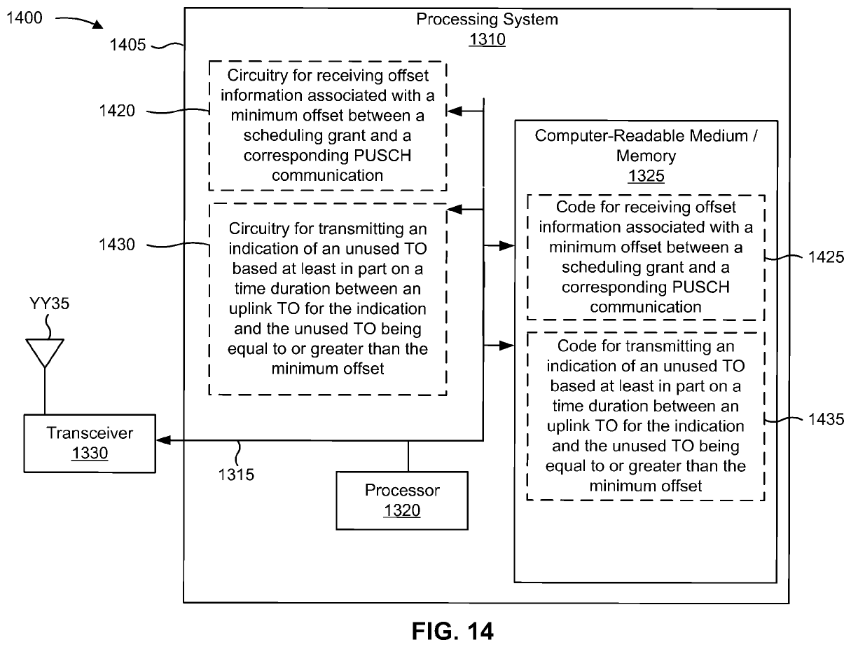

FIG. 14 is a diagram illustrating an example 1400 of an implementation of code and circuitry for an apparatus 1405, in accordance with the present disclosure. The circuity may include processing circuitry and memory circuitry. The apparatus 1405 may be a UE, or a UE may include the apparatus 1405.

As shown in FIG. 14, the apparatus 1405 may include circuitry for receiving offset information associated with a minimum offset between a scheduling grant and a corresponding PUSCH communication (circuitry 1420). For example, the circuitry 1420 may enable the apparatus 1405 to receive offset information associated with a minimum offset between a scheduling grant and a corresponding PUSCH communication.

As shown in FIG. 14, the apparatus 1405 may include, stored in computer-readable medium 1325, code for receiving offset information associated with a minimum offset between a scheduling grant and a corresponding PUSCH communication (code 1425). For example, the code 1425, when executed by processor 1320, may cause processor 1320 to cause transceiver 1330 to receive offset information associated with a minimum offset between a scheduling grant and a corresponding PUSCH communication.

As shown in FIG. 14, the apparatus 1405 may include circuitry for transmitting an indication of an unused TO based at least in part on a time duration between an uplink TO for the indication and the unused TO being equal to or greater than the minimum offset (circuitry 1430). For example, the circuitry 1430 may enable the apparatus 1405 to transmit an indication of an unused TO based at least in part on a time duration between an uplink TO for the indication and the unused TO being equal to or greater than the minimum offset.

As shown in FIG. 14, the apparatus 1405 may include, stored in computer-readable medium 1325, code for transmitting an indication of an unused TO based at least in part on a time duration between an uplink TO for the indication and the unused TO being equal to or greater than the minimum offset (code 1435). For example, the code 1435, when executed by processor 1320, may cause processor 1320 to cause transceiver 1330 to transmit an indication of an unused TO based at least in part on a time duration between an uplink TO for the indication and the unused TO being equal to or greater than the minimum offset.

FIG. 14 is provided as an example. Other examples may differ from what is described in connection with FIG. 14.

FIG. 15 is a diagram of an example apparatus 1500 for wireless communication, in accordance with the present disclosure. The apparatus 1500 may be a network entity (e.g., network node 110, network entity 810), or a network entity may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150) may include an offset component 1508, among other examples.

In some aspects, the apparatus 1500 may be configured to perform one or more operations described herein in connection with FIGS. 1-9. Additionally, or alternatively, the apparatus 1500 may be configured to perform one or more processes described herein, such as process 1100 of FIG. 11. In some aspects, the apparatus 1500 and/or one or more components shown in FIG. 15 may include one or more components of the network entity described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network entity described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network entity described in connection with FIG. 2. In some aspects, the transmission component 1504 may be co-located with the reception component 1502 in a transceiver.

The offset component 1508 may generate offset information associated with a minimum offset between a scheduling grant and a corresponding PUSCH communication and associated with a UE determining to transmit an indication of an unused TO. The transmission component 1504 may transmit the offset information.

The reception component 1502 may receive an indication of the unused TO. The reception component 1502 may receive, from each UE of multiple UEs, capability information that indicates an offset capability of the UE, and the offset component 1508 may generate offset information based at least in part on the capability information for each UE.

The transmission component 1504 may transmit a quantity threshold of UEs associated with transmission of a TO. The transmission component 1504 may transmit an updated quantity threshold.

The transmission component 1504 may transmit updated offset information. The transmission component 1504 may transmit multiple offset candidates with corresponding indices via an RRC message or a MAC CE, and the transmission component 1504 may transmit a WUS that includes an index that corresponds to an offset candidate.

The transmission component 1504 may transmit multiple offset value candidates and a quantity of UEs for each offset candidate, and the transmission component 1504 may transmit a WUS that increments or decrements the quantity of UEs for an offset candidate.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

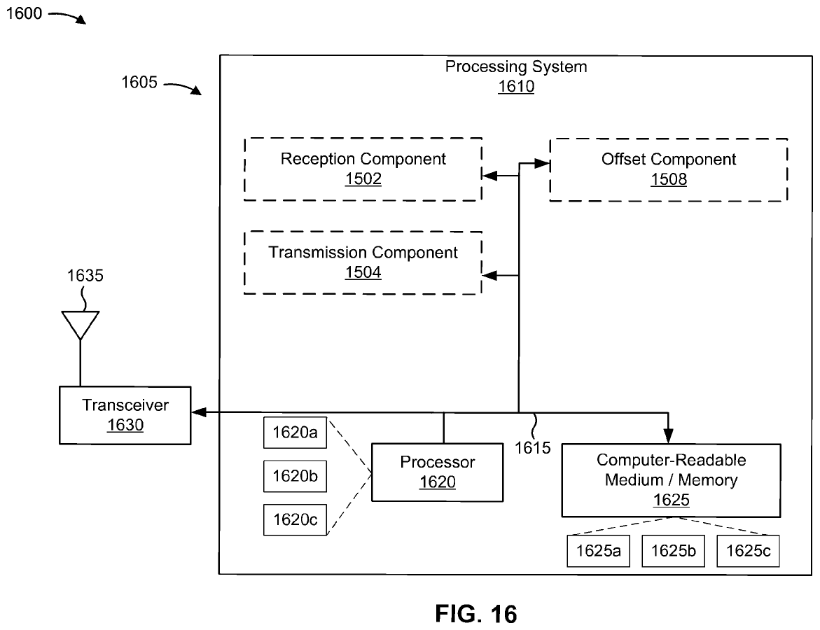

FIG. 16 is a diagram illustrating an example 1600 of a hardware implementation for an apparatus 1605 employing a processing system 1610, in accordance with the present disclosure. The apparatus 1605 may be a network entity.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors and/or hardware components, represented by the processor (or processing circuitry) 1620, the illustrated components, and the computer-readable medium/memory (or memory circuitry)1625. The processor 1320 may include multiple processors, such as processor 1302a, memory 1320b, and memory 1320c. The memory 1325 may include multiple memories, such as memory 1325a, memory 1325b, and memory 1325c. The bus 1615 may also link various other circuits, such as timing sources, peripherals, voltage regulators, and/or power management circuits.

The processing system 1610 may be coupled to a transceiver 1630. The transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1504, and generates a signal to be applied to the one or more antennas 1635 based at least in part on the received information.

The processing system 1610 includes a processor 1620 coupled to a computer-readable medium/memory 1625. The processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software. The processing system further includes at least one of the illustrated components. The components may be software modules running in the processor 1620, resident/stored in the computer readable medium/memory 1625, one or more hardware modules coupled to the processor 1620, or some combination thereof.

In some aspects, the processing system 1610 may be a component of the base station 110 and may include the memory 242 and/or at least one of the TX MIMO processor 230, the RX processor 238, and/or the controller/processor 240. In some aspects, the apparatus 1605 for wireless communication includes means for generating offset information associated with a minimum offset between a scheduling grant and a corresponding PUSCH communication and associated with a UE determining to transmit an indication of an unused TO. In some aspects, the apparatus 1605 for wireless communication includes means for transmitting the offset information. The aforementioned means may be one or more of the aforementioned components of the apparatus 1500 and/or the processing system 1610 of the apparatus 1605 configured to perform the functions recited by the aforementioned means. As described elsewhere herein, the processing system 1610 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 16 is provided as an example. Other examples may differ from what is described in connection with FIG. 16.

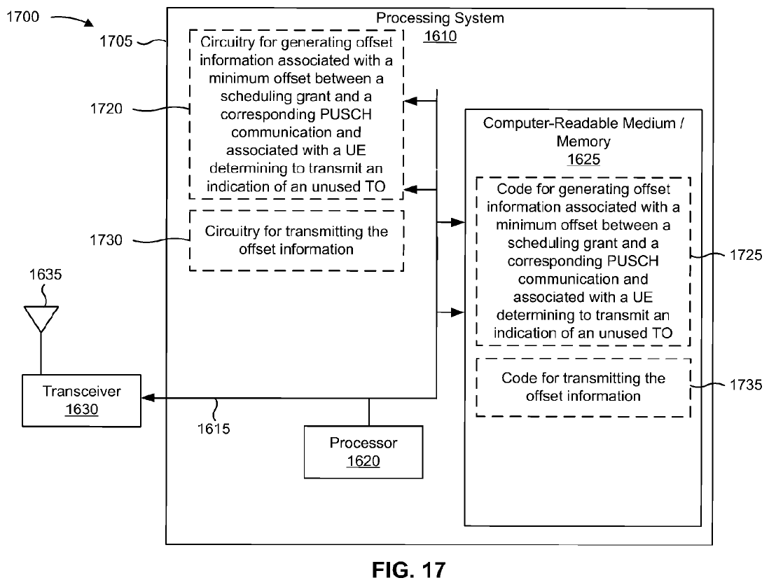

FIG. 17 is a diagram illustrating an example 1700 of an implementation of code and circuitry for an apparatus 1705, in accordance with the present disclosure. The circuity may include processing circuitry and memory circuitry. The apparatus 1705 may be a network entity, or a network entity may include the apparatus 1705.

As shown in FIG. 17, the apparatus 1705 may include circuitry for generating offset information associated with a minimum offset between a scheduling grant and a corresponding PUSCH communication and associated with a UE determining to transmit an indication of an unused TO (circuitry 1720). For example, the circuitry 1720 may enable the apparatus 1705 to generate offset information associated with a minimum offset between a scheduling grant and a corresponding PUSCH communication and associated with a UE determining to transmit an indication of an unused TO.

As shown in FIG. 17, the apparatus 1705 may include, stored in computer-readable medium 1625, code for generating offset information associated with a minimum offset between a scheduling grant and a corresponding PUSCH communication and associated with a UE determining to transmit an indication of an unused TO (code 1725). For example, the code 1725, when executed by processor 1620, may cause processor 1620 to generate offset information associated with a minimum offset between a scheduling grant and a corresponding PUSCH communication and associated with a UE determining to transmit an indication of an unused TO.

As shown in FIG. 17, the apparatus 1705 may include circuitry for transmitting the offset information (circuitry 1730). For example, the circuitry 1730 may enable the apparatus 1705 to transmit the offset information.

As shown in FIG. 17, the apparatus 1705 may include, stored in computer-readable medium 1625, code for transmitting the offset information (code 1735). For example, the code 1735, when executed by processor 1620, may cause processor 1620 to cause transceiver 1630 to transmit the offset information.

FIG. 17 is provided as an example. Other examples may differ from what is described in connection with FIG. 17.

The following provides an overview of some Aspects of the present disclosure:

Aspect 1: A method of wireless communication performed at a user equipment (UE), comprising: receiving offset information associated with a minimum offset between a scheduling grant and a corresponding physical uplink shared channel (PUSCH) communication; and transmitting an indication of an unused transmission occasion (TO) based at least in part on a time duration between an uplink TO for the indication and the unused TO being equal to or greater than the minimum offset.

Aspect 2: The method of Aspect 1, further comprising transmitting capability information that indicates an offset capability of the UE.

Aspect 3: The method of any of Aspects 1-2, wherein the offset information indicates the minimum offset.

Aspect 4: The method of any of Aspects 1-3, wherein receiving the offset information includes receiving the offset information in a radio resource control message.

Aspect 5: The method of Aspect 4, wherein the offset information is associated with a configuration for PUSCH configured grant.

Aspect 6: The method of any of Aspects 1-5, wherein receiving the offset information includes receiving the offset information in downlink control information or a medium access control control element (MAC CE) that is associated with PUSCH configured grant.

Aspect 7: The method of any of Aspects 1-6, wherein the offset information includes a quantity of offset candidates associated with multiple UEs, and wherein the method includes selecting the minimum offset from among the offset candidates.

Aspect 8: The method of Aspect 7, wherein transmitting the indication of the unused TO includes transmitting the indication of the unused TO further based at least in part on the quantity of offset candidates satisfying a quantity threshold.

Aspect 9: The method of Aspect 8, further comprising receiving the quantity threshold via a first downlink control information (DCI) or a first medium access control control element (MAC CE).

Aspect 10: The method of Aspect 9, further comprising receiving an updated quantity threshold via a second DCI or a second MAC CE.

Aspect 11: The method of Aspect 8, further comprising receiving the quantity threshold via a first radio resource control (RRC) message.

Aspect 12: The method of Aspect 11, further comprising receiving an updated quantity threshold via a second RRC message.

Aspect 13: The method of any of Aspects 1-12, further comprising receiving updated offset information that includes an updated quantity of offset candidates.

Aspect 14: The method of any of Aspects 1-13, further comprising receiving updated offset information that indicates an updated minimum offset.

Aspect 15: The method of any of Aspects 1-14, wherein receiving the offset information includes receiving the offset information in a wake up signal.

Aspect 16: The method of any of Aspects 1-15, further comprising receiving updated offset information in a wake up signal.

Aspect 17: The method of any of Aspects 1-16, further comprising receiving multiple offset candidates with corresponding indices via a radio resource control message or a medium access control control element (MAC CE), and wherein receiving the offset information includes receiving a wake up signal that includes an index that corresponds to an offset candidate.

Aspect 18: The method of any of Aspects 1-17, further comprising receiving multiple offset candidates and a quantity of UEs for each offset candidate, and wherein the method includes receiving a wake up signal that increments or decrements the quantity of UEs for an offset candidate.

Aspect 19: The method of any of Aspects 1-18, wherein receiving the offset information includes receiving the offset information in a broadcast or a multicast.

Aspect 20: A method of wireless communication performed at a network entity, comprising: generating offset information associated with a minimum offset between a scheduling grant and a corresponding physical uplink shared channel (PUSCH) communication and associated with a user equipment (UE) determining to transmit an indication of an unused transmission occasion (TO); and transmitting the offset information.

Aspect 21: The method of Aspect 20, further comprising receiving an indication of the unused TO.

Aspect 22: The method of any of Aspects 20-21, further comprising receiving, from each UE of multiple UEs, capability information that indicates an offset capability of the UE, and wherein generating the offset information includes generating the offset information based at least in part on the capability information for each UE.

Aspect 23: The method of any of Aspects 20-22, wherein the offset information indicates the minimum offset.

Aspect 24: The method of any of Aspects 20-23, wherein the offset information includes a quantity of offset candidates associated with multiple UEs.

Aspect 25: The method of any of Aspects 20-24, further comprising transmitting a quantity threshold of UEs associated with transmission of a TO.

Aspect 26: The method of Aspect 25, further comprising transmitting an updated quantity threshold.

Aspect 27: The method of any of Aspects 20-26, further comprising transmitting updated offset information.

Aspect 28: The method of any of Aspects 20-27, further comprising transmitting multiple offset candidates with corresponding indices via a radio resource control message or a medium access control control element (MAC CE), and wherein transmitting the offset information includes transmitting a wake up signal that includes an index that corresponds to an offset candidate.

Aspect 29: The method of any of Aspects 20-28, further comprising transmitting multiple offset value candidates and a quantity of UEs for each offset candidate, and wherein the method includes transmitting a wake up signal that increments or decrements the quantity of UEs for an offset candidate.

Aspect 30: The method of any of Aspects 20-29, wherein transmitting the offset information includes transmitting the offset information in a broadcast or a multicast.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A user equipment (UE) for wireless communication, comprising: a processing system that includes processor circuitry and memory circuitry that stores code and is coupled with the processor circuitry, the processing system configured to cause the UE to perform the method of one or more of Aspects 1-19.

Aspect 37: An apparatus for wireless communication at a user equipment (UE), comprising: one or more memories; and one or more processors coupled to the one or more memories, the one or more processors configured to cause the UE to: receive offset information associated with a minimum offset between a scheduling grant and a corresponding physical uplink shared channel (PUSCH) communication; and transmit an indication of an unused transmission occasion (TO) based at least in part on a time duration between an uplink TO for the indication and the unused TO being equal to or greater than the minimum offset.

Aspect 38: The apparatus of Aspect 37, wherein the one or more processors are configured, individually or collectively, to cause the UE to: receive offset information associated with a minimum offset between a scheduling grant and a corresponding physical uplink shared channel (PUSCH) communication; and transmit an indication of an unused transmission occasion (TO) based at least in part on a time duration between an uplink TO for the indication and the unused TO being equal to or greater than the minimum offset.

Aspect 39: A network entity for wireless communication, comprising: a processing system that includes processor circuitry and memory circuitry that stores code and is coupled with the processor circuitry, the processing system configured to cause the network entity to perform the method of one or more of Aspects 20-30.

Aspect 40: An apparatus for wireless communication at a network entity, comprising: one or more memories; and one or more processors coupled to the one or more memories, the one or more processors configured to cause the network entity to: generate offset information associated with a minimum offset between a scheduling grant and a corresponding physical uplink shared channel (PUSCH) communication and associated with an indication of an unused transmission occasion (TO); and transmit the offset information.

Aspect 41: The apparatus of Aspect 40, wherein the one or more processors are configured, individually or collectively, to cause the network entity to: generate offset information associated with a minimum offset between a scheduling grant and a corresponding physical uplink shared channel (PUSCH) communication and associated with an indication of an unused transmission occasion (TO); and transmit the offset information.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
one or more memories storing processor-executable code; and
one or more processors coupled with the one or more memories and configured to cause the UE to:
receive offset information associated with a minimum offset between a scheduling grant and a corresponding physical uplink shared channel (PUSCH) communication; and
transmit an indication of an unused transmission occasion (TO) based at least in part on a time duration between an uplink TO for the indication and the unused TO being equal to or greater than the minimum offset.

2. The apparatus of claim 1, wherein the one or more processors are configured to cause the UE to transmit capability information that indicates an offset capability of the UE.

3. The apparatus of claim 1, wherein the offset information indicates the minimum offset.

4. The apparatus of claim 1, wherein the one or more processors, to receive the offset information, are configured to cause the UE to receive the offset information in a radio resource control message.

5. (canceled)

6. The apparatus of claim 1, wherein the one or more processors, to receive the offset information, are configured to cause the UE to receive the offset information in downlink control information or a medium access control control element (MAC CE) that is associated with PUSCH configured grant.

7. The apparatus of claim 1, wherein the offset information includes a quantity of offset candidates associated with multiple UEs, and wherein the one or more processors are configured to cause the UE to select the minimum offset from among the offset candidates.

8-12. (canceled)

13. The apparatus of claim 1, wherein the one or more processors are configured to cause the UE to receive updated offset information that includes an updated quantity of offset candidates.

14. The apparatus of claim 1, wherein the one or more processors are configured to cause the UE to receive updated offset information that indicates an updated minimum offset.

15. The apparatus of claim 1, wherein the one or more processors, to receive the offset information, are configured to cause the UE to receive the offset information in a wake up signal.

16. The apparatus of claim 1, wherein the one or more processors are configured to cause the UE to receive updated offset information in a wake up signal.

17. The apparatus of claim 1, wherein the one or more processors are configured to cause the UE to receive multiple offset candidates with corresponding indices via a radio resource control message or a medium access control control element (MAC CE), and wherein the one or more processors, to receive the offset information, are configured to receive a wake up signal that includes an index that corresponds to an offset candidate.

18. The apparatus of claim 1, wherein the one or more processors are configured to cause the UE to receive multiple offset candidates and a quantity of UEs for each offset candidate, and wherein the one or more processors are configured to cause the UE to receive a wake up signal that increments or decrements the quantity of UEs for an offset candidate.

19. The apparatus of claim 1, wherein the one or more processors, to receive the offset information, are configured to cause the UE to receive the offset information in a broadcast or a multicast.

20. An apparatus for wireless communication at a network entity, comprising:
one or more memories storing processor-executable code; and
one or more processors coupled with the one or more memories and configured to cause the network entity to:
generate offset information associated with a minimum offset between a scheduling grant and a corresponding physical uplink shared channel (PUSCH) communication and associated with an indication of an unused transmission occasion (TO); and
transmit the offset information.

21. The apparatus of claim 20, wherein the one or more processors are configured to cause the network entity to receive the indication of the unused TO.

22. The apparatus of claim 20, wherein the one or more processors are configured to cause the network entity to receive, from each UE of multiple UEs, capability information that indicates an offset capability of the UE, and wherein the one or more processors, to generate the offset information, are configured to generate the offset information based at least in part on the capability information of each UE.

23. The apparatus of claim 20, wherein the offset information indicates the minimum offset.

24. The apparatus of claim 20, wherein the offset information includes a quantity of offset candidates associated with multiple UEs.

25. The apparatus of claim 20, wherein the one or more processors are configured to cause the network entity to transmit a quantity threshold of UEs associated with transmission of a TO.

26. The apparatus of claim 25, wherein the one or more processors are configured to cause the network entity to transmit an updated quantity threshold.

27-30. (canceled)
